(19) United States
(12) Patent Application Publication
(10) Pub. No.: US 2010/0312879 A1
(43) Pub. Date: Dec. 9, 2010

(54) PLUG-IN PROVISIONING INTEGRATION IN A CLUSTERED ENVIRONMENT

(75) Inventor: David Taieb, Westford, MA (US)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/481,494

(22) Filed: Jun. 9, 2009

(51) Int. Cl. G06F 15/173

(52) U.S. Cl. 709/224

(57) ABSTRACT

Embodiments of the present invention address deficiencies of the art in respect to plug-in deployment for component based applications in general and provide a method, system and computer program product for plug-in deployment in a clustered environment. In an embodiment of the invention, a method for plug-in deployment in a clustered environment can be provided. The method can include adding a plug-in for a component based application to a plug-in repository for the component based application. The component based application itself can execute in a node provided by a server in a clustered computing environment. The method further can include directing replication of the added plug-in in the node to other plug-in repositories in other nodes provided by other servers in the clustered computing environment.

### BACKGROUND OF THE INVENTION

1. Field of the Invention

The present invention relates to the field of dynamic component model deployment in a clustered environment and more particularly to plug-in provisioning for a clustered environment implementing a dynamic component model.

2. Description of the Related Art

The notion of a component model finds its modern origin in distributed computing and in particular, distributed applications composed of different distributed components accessible through the World Wide Web (the “Web”). The component models has proven an effective framework upon which distributed applications can be deployed by compartmentalizing bundles of logic externally described in separate meta-information so that application variants can be deployed on the fly without requiring custom software development and deployment for each variant. Further, code lifecycle maintenance can be simplified by allowing the replacement of different objects in a bundle on the fly without mandating a complete code rewrite of the entire application.

Early component models resulted in technologies such as Java version 2.0 enterprise edition (“J2EE”) container based applications and, servlet oriented applications. More recently, the Open Services Gateway Initiative (OSGI) working group proposed and specified a dynamic component model defining an architecture for modular application development. OSGI applications or components as bundled for deployment, can be remotely installed, started, stopped, updated and uninstalled without requiring a reboot. OSGI further specified the management of packages and classes and life cycle management can be performed by way of an application programming interface (“API”) that allows for remote downloading of management policies. Finally, a service registry allows bundles to detect the addition of new services, or the removal of services, and to adapt accordingly. The OSGI specification original focused upon service gateways; however, more recently the OSGI specification has found widespread adoption in other applications including those integrating the Eclipse™ integrated development environment (IDE) provided by the Eclipse Foundation of Portland, Oreg., with the dynamic component model of the OSGI framework.

Eclipse is a multi-language software development platform that provides an IDE and a plug-in system to extend the IDE. Eclipse enjoys widespread use to develop applications. Of note, Eclipse users can extend the capabilities of the Eclipse environment by installing plug-ins compliant with the Eclipse framework, such as development toolkits for other programming languages. Eclipse recently has formed the base environment for a number of end user applications including popular collaboration and messaging suites such as the Lotus Notes™ messaging client for a variety of computing platforms including the Windows™ platform and the OS X™ platform. Indeed, portions of the Eclipse codebase have been incorporated into the OS X platform.

Provisioning plug-ins within the Eclipse environment is not without its challenges. In the context of OSGI, provisioning plug-ins, known in OSGI as “bundles” can be even more problematic. Specifically, the provisioning process must be manually repeated for each node in a target cluster. While a manual provisioning process can be acceptable if new features for the Eclipse based application embodied within the bundles are part of a new version of a server, the same is not true when the features for the Eclipse based application embodied within the bundles are supplied by the end user. In this regard, the end user generally expects the clustering replication process of the deployment manager and not the end user to update the nodes of the target cluster with the bundles embodying the new features for the Eclipse based application.

### BRIEF SUMMARY OF THE INVENTION

Embodiments of the present invention address deficiencies of the art in respect to plug-in deployment for component based applications in general and provide a novel and non-obvious method, system and computer program product for plug-in deployment in a clustered environment. In an embodiment of the invention, a method for plug-in deployment in a clustered environment can be provided. The method can include adding a plug-in for a component based application to a plug-in repository for the component based application. The component based application itself can execute in a node provided by a server in a clustered computing environment. The method further can include directing replication of the added plug-in in the node to other plug-in repositories in other nodes provided by other servers in the clustered computing environment.

In one aspect of the embodiment, adding a plug-in to the plug-in repository for the component based application can include receiving a plug-in for storage in the plug-in repository and identifying a location in the plug-in repository in which to store the received plug-in. Thereafter, the plug-in can be in the plug-in repository at the identified location. Alternatively, in another aspect of the embodiment, adding a plug-in to the plug-in repository for the component based application can include receiving a plug-in for storage in the plug-in repository by way of a restful state transfer (REST) service executing in a server remotely from the node. A location in the plug-in repository in which to store the received plug-in can be identified within the REST service and the plug-in can be stored by the REST service in the plug-in repository at the identified location. As yet another alternative, adding a plug-in to the plug-in repository for the component based application can include receiving a plug-in for storage in the plug-in repository by way of hypertext transfer protocol (HTTP) over file transfer protocol (FTP) communications, file shares and the like, with a service executing in a server remotely from the node.

Of note, in yet another aspect of the embodiment, directing replication of the added plug-in to the plug-in repository can include monitoring the plug-in repository for changes to the plug-in repository. An addition of the added plug-in to the plug-in repository can be detected and, in response to the detection, a replication function can be invoked in the clustered computing environment within the node for the added plug-in. Alternatively, directing replication of the added plug-in to the plug-in repository can include receiving from the REST service an invocation of a replication function in the clustered computing environment within the node for the added plug-in.

In another embodiment of the invention, a data processing system can provide a clustered environment supporting plug-in deployment. The system can include different nodes in a clustered computing environment, each hosted by a server amongst a set of servers in the clustered computing environment. Further, each of the servers can be communicatively coupled to one another in the clustered computing environment. The system also can include a component based application executing separately in each of the nodes, each utilizing multiple different plug-ins disposed in a corresponding plug-in repository, for example a Web application archive (WAR) file. Importantly, a replication function can be provided by the clustered computing environment in each one of the nodes. Finally, the system can include user triggered plug-in provisioning logic. The logic can include program code executing in a computing system remotely from the nodes and enabled to add a plug-in to a plug-in repository stored in a primary one of the nodes at a location specified for the plug-in repository for replication by the primary one of the nodes to others of the nodes by way of the replication function.

In various aspects of the foregoing embodiment, the component based application can be an Eclipse based application extended by the plug-ins disposed in the corresponding plug-in repository. Additionally, the replication function can be provided for each of the nodes by an OSGI framework implementation executing in each of the nodes. Optionally, a plug-in synchronizer can be included and can execute in each of the nodes. The plug-in synchronizer can include separate program code enabled to monitor a corresponding plug-in repository to detect changes to the corresponding plug-in repository and to invoke the replication function to replicate an added plug-in to other plug-in repositorys in other nodes in the clustered computing environment. Finally, a REST service executing in a server remote from the nodes can be configured to provide to a primary node amongst the nodes the plug-in to be added to the plug-in repository at a location in the plug-in repository specified by the REST service and to invoke the replication function.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for plug-in deployment in a clustered environment;

FIG. 2 is a schematic illustration of a data processing system providing a clustered environment supporting plug-in deployment; and,

FIG. 3 is a flow chart illustrating a process for plug-in deployment in a clustered environment.

### DETAILED DESCRIPTION OF THE INVENTION

Embodiments of the present invention provide a method, system and computer program product for plug-in deployment in a clustered environment. In accordance with an embodiment of the present invention, an archive of plug-ins for a component based application executing in the primary node can be established in a primary node of a cluster of nodes in a clustered computing architecture. The plug-ins within the archive can be replicated to corresponding plug-in repositorys in respectively different, other nodes in the cluster. To provision a new plug-in to the cluster, the plug-in can be deployed to the plug-in repository in the primary node and, responsive to detecting the change in the plug-in repository, the primary node can replicate the newly added plug-in to the corresponding plug-in repositorys in the respectively different, other nodes in the cluster. In this way, the operation of plug-in deployment of plug-ins in a component based application can be integrated with the clustering of the component based application in a clustered environment to support the objectives of high-availability and resiliency.

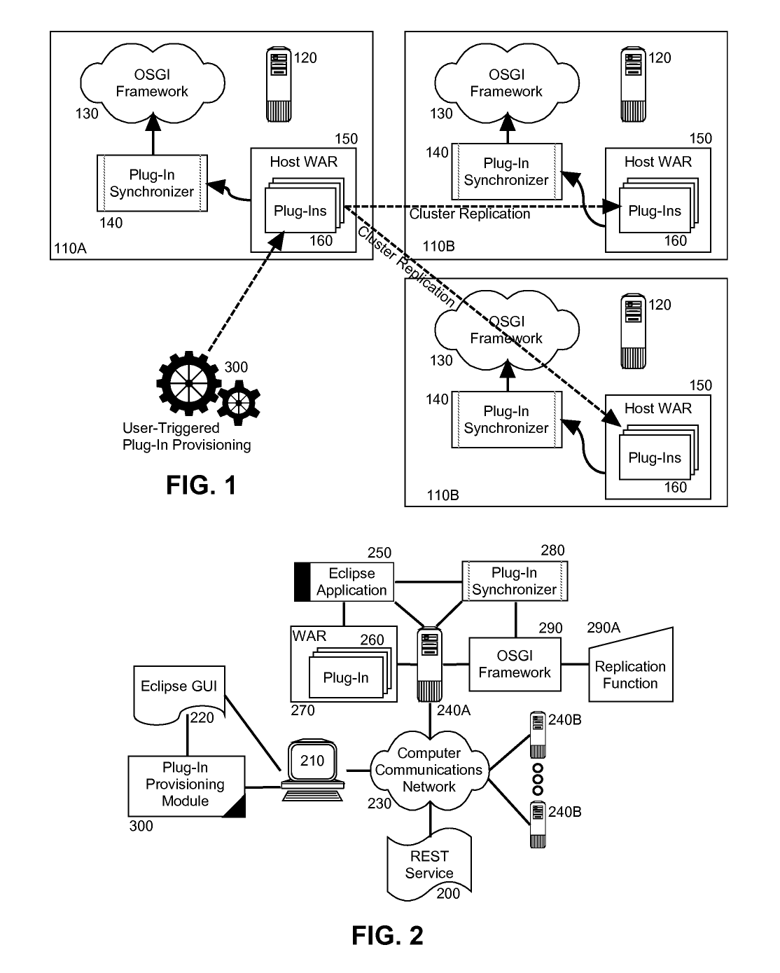

In further illustration, FIG. 1 is a pictorial illustration of a process for plug-in deployment in a clustered environment. As shown in FIG. 1, a clustered environment can be provided for a component based application such as that built upon the Eclipse environment. Each node 110A, 110B in the cluster can include a host server 120 with processor and memory supporting the execution of the component based application including one or more plug-ins 160 disposed within a plug-in repository such as a WAR file 150. The clustered environment can be arranged in accordance with the OSGI framework 130 in order to provide distributed redundancy of the component based application in the nodes 110A, 110B.

In operation, user triggered plug-in provisioning logic 300 executing in a computing system with processor and memory accessible by an end user through a requisite user interface can receive a selection of one or more plug-ins to be deployed to a primary node 110A amongst the nodes 110A, 110B. Thereafter, a location within the WAR 150 of the primary node 110A can be specified within the user interface and the logic 300 can deploy the selection of one or more plug-ins to the location in the WAR 150 of the primary node 110A. Plug-In Synchronizer 140 executing in the memory by a processor of the server 120 of the primary node 110A can detect a change to the WAR 150 and can trigger replication of the selection of one or more plug-ins to the WAR 150 of each of the other nodes 110B in the clustered environment. In this way, the deployment of plug-ins to the component based application can be accomplished within a clustered environment in an automated fashion without requiring the tedious and error-prone manual deployment of the plug-ins to each node 110A, 110B in the clustered environment.

The process described in connection with FIG. 1 can be implemented within a data processing system providing a clustered environment and supporting plug-in deployment for a component based application. In specific illustration, FIG. 2 is a schematic illustration of a data processing system providing a clustered environment supporting plug-in deployment. The system can include multiple different servers 240A, 240B communicatively coupled to one another over computer communications network 230. Each of the servers 240A, 240B can host one or more nodes within which a component based application 250 such as an Eclipse application, executes utilizing plug-ins 260 disposed in a plug-in repository 270. Further, each node in each of the servers 240A, 240B can include an OSGI framework implementation 290 in computer program code to form a clustered environment amongst the nodes of the servers 240A, 240B. (Of note, only server 240A is shown to include a single node of the component based application 250, the plug-ins 260 disposed within the plug-in repository 270 and the OSGI framework implementation 290 for illustrative simplicity).

Importantly, a plug-in synchronizer 280 can execute in the node of the server 240A. The plug-in synchronizer 280 can be configured to monitor the plug-in repository 270 for changes with respect to the plug-ins 260 disposed within the plug-in repository 270. The plug-in synchronizer 280 further can be configured to respond to a detection of changes in the monitored plug-in repository 270 by invoking replication functionality 290A in the OSGI framework implementation 290 to replicate the detected changes in the plug-in repository to plug-in repositorys residing in the other nodes of other servers 240B.

An end user computing system 210 also can be coupled to at least the server 240A over the computer communications network 230. The end user computing system 210 can provide a user interface 220 to the Eclipse application 250. The end user computing system 210 also can include plug-in provisioning module 300 including computer program code fixed within a computer readable medium and executing in memory by a processor of the end user computing system 210. It will be recognized by the skilled artisan, however, that the plug-in provisioning module 300 need not be stored in end user computing system 210 and can be provided into the memory of the end user computing system 210 by remotely disposed computing system such as the server 240A.

The program code of the plug-in provisioning module 300 can be enabled when executed by the end user computing system 210 to deploy a set of one or more plug-ins to a location specified for the plug-in repository 270 stored in the node of the server 240A. In this regard, in one aspect of an embodiment of the invention, the set of one or more plug-ins, and the location in the plug-in repository 270 can be specified by an end user through the an input screen (such as a Web page) provided by the user interface 220. Script logic included within or referenced by the input screen then can copy the set of one or more plug-ins to the specified location in the plug-in repository 270. Concurrently, the plug-in synchronizer 280 can detect the changes to the plug-in repository and invoke the replication functionality 290A of the OSGI framework implementation to replicate the changes to the plug-in repository 270 to the other nodes in the other servers 240B.

In an alternative aspect of the embodiment, a screen can be provided through which a directory in the plug-in repository can be specified along with the selection of one or more plug-ins. However, a restful (REST) service 200 subsequently can be invoked through a Web browser (not shown) executing in the end user computing system 210 to copy the plug-ins in the specified set to the specified location in the plug-in repository 270. Additionally, without the assistance of the plug-in synchronizer 280, the REST service 200 can invoke the replication functionality 290A of the OSGI framework implementation 290 to cause the replication of the plug-ins in the set to corresponding plug-in repositorys in respective ones of the nodes of the servers 240B.

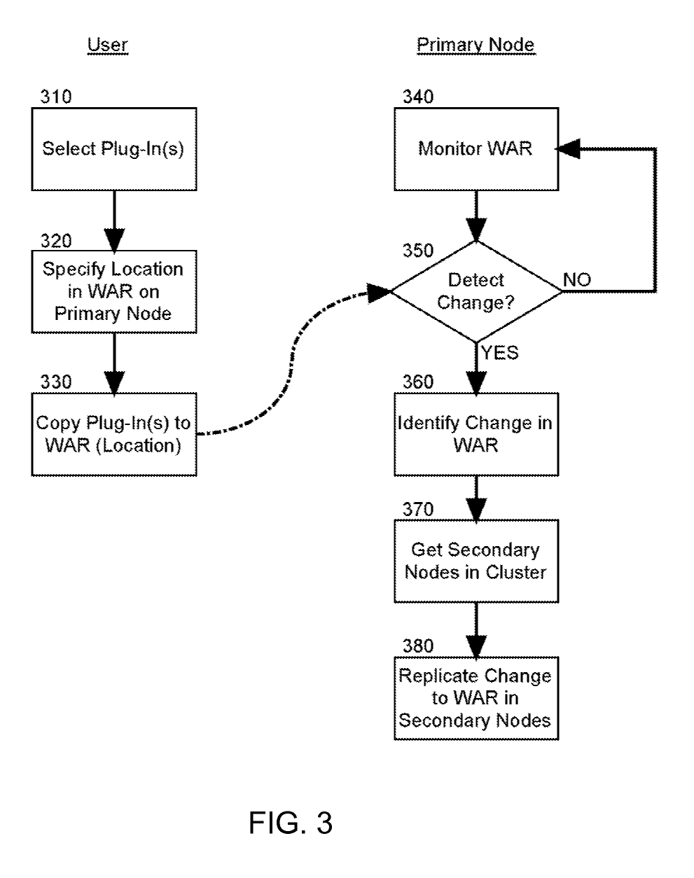

In even yet further illustration of FIG. 3 is a flow chart illustrating a process for plug-in deployment in a clustered environment. The process can begin with an end user in block 310 with the selection of a set of one or more plug-ins to be deployed for use in a component based application executing remotely and redundantly in a clustered environment. In block 320, a location storing a plug-in repository for the component based application can be specified by the end user. Thereafter, in block 330 the plug-ins in the set can be copied to the specified location in the plug-in repository within a primary node of the clustered environment.

In block 340, the plug-in repository can be monitored within the primary node to detect changes in the plug-in repository. In decision block 350, if changes are detected within the plug-in repository, in block 360 the changes to the plug-in repository, namely the addition of one or more plug-ins (or perhaps the removal of one or more plug-ins), can be identified. Subsequently, in block 370 at least one secondary node in the clustered environment can be selected and in block 380 the changes to the plug-in repository can be replicated to a corresponding plug-in repository in the secondary node—or instance, by invoking the replication functionality of a supporting OSGI framework implementation in the primary node of the clustered environment. Accordingly, the plug-in can be deployed into a number of nodes in the clustered environment without requiring a tedious and error-prone manual process of individually deploying the plug-ins to each component based application in each node of the clustered environment.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for plug-in deployment in a clustered environment, the method comprising:
adding a plug-in for a component based application to a plug-in repository for the component based application executing in a node provided by a server in a clustered computing environment; and,
directing replication of the added plug-in to other plug-in repositorys in other nodes provided by other servers in the clustered computing environment.

2. The method of claim 1, wherein adding a plug-in to the plug-in repository for the component based application comprises:
receiving a plug-in for storage in the plug-in repository;
identifying a location in the plug-in repository in which to store the received plug-in; and,
storing the plug-in in the plug-in repository at the identified location.

3. The method of claim 1, wherein adding a plug-in to the plug-in repository for the component based application comprises:
receiving a plug-in for storage in the plug-in repository by way of a service executing in a server remotely from the node;
identifying within the service a location in the plug-in repository in which to store the received plug-in; and,
storing by the service the plug-in in the plug-in repository at the identified location.

4. The method of claim 1, wherein directing replication of the added plug-in to the plug-in repository comprises:
monitoring the plug-in repository for changes to the plug-in repository;
detecting an addition of the added plug-in to the plug-in repository; and,
responsive to the detection, invoking a replication function in the clustered computing environment within the node for the added plug-in.

5. The method of claim 3, wherein directing replication of the added plug-in to the plug-in repository comprises:
receiving from the service an invocation of a replication function in the clustered computing environment within the node for the added plug-in.

6. A data processing system providing a clustered environment supporting plug-in deployment, the system comprising:
a plurality of nodes in a clustered computing environment, each of the nodes hosted by a server amongst a plurality of servers in the clustered computing environment, each of the servers being communicatively coupled to one another in the clustered computing environment;
a component based application executing separately in each of the nodes, each application utilizing a plurality of plug-ins disposed in a corresponding plug-in repository;
a replication function provided by the clustered computing environment in each one of the nodes; and,
user triggered plug-in provisioning logic comprising program code executing in a computing system remotely from the nodes and enabled to add a plug-in to a plug-in repository stored in a primary one of the nodes at a location specified for the plug-in repository for replication by the primary one of the nodes to others of the nodes by way of the replication function.

7. The system of claim 6, wherein the component based application is an Eclipse based application extended by the plug-ins disposed in the corresponding plug-in repository.

8. The system of claim 6, wherein the replication function is provided for each of the nodes by an Open Services Gateway Initiative (OSGI) framework implementation executing in each of the nodes.

9. The system of claim 6, further comprising a plug-in synchronizer executing in each of the nodes, the plug-in synchronizer comprising program code enabled to monitor a corresponding plug-in repository to detect changes to the corresponding plug-in repository and to invoke the replication function to replicate an added plug-in to other plug-in repositorys in other nodes in the clustered computing environment.

10. The system of claim 6, further comprising a service executing in a server remote from the nodes, the service being configured to provide to a primary one of the nodes the plug-in to be added to the plug-in repository at a location in the plug-in repository specified by the service and to invoke the replication function.

11. The system of claim 6, wherein each plug-in repository is a Web archive (WAR) file.

12. A computer program product comprising a computer usable medium embodying computer usable program code for plug-in deployment in a clustered environment, the computer program product comprising:
computer usable program code for adding a plug-in for a component based application to a plug-in repository for the component based application executing in a node provided by a server in a clustered computing environment; and,
computer usable program code for directing replication of the added plug-in to other plug-in repositorys in other nodes provided by other servers in the clustered computing environment.

13. The computer program product of claim 12, wherein the computer usable program code for adding a plug-in to the plug-in repository for the component based application comprises:
computer usable program code for receiving a plug-in for storage in the plug-in repository;
computer usable program code for identifying a location in the plug-in repository in which to store the received plug-in; and,
computer usable program code for storing the plug-in in the plug-in repository at the identified location.

14. The computer program product of claim 12, wherein the computer usable program code for adding a plug-in to the plug-in repository for the component based application comprises:
computer usable program code for receiving a plug-in for storage in the plug-in repository by way of a service executing in a server remotely from the node;
computer usable program code for identifying within the service a location in the plug-in repository in which to store the received plug-in; and,
computer usable program code for storing by the service the plug-in in the plug-in repository at the identified location.

15. The computer program product of claim 12, wherein the computer usable program code for directing replication of the added plug-in to the plug-in repository comprises:
computer usable program code for monitoring the plug-in repository for changes to the plug-in repository;
computer usable program code for detecting an addition of the added plug-in to the plug-in repository; and,
computer usable program code for responsive to the detection, invoking a replication function in the clustered computing environment within the node for the added plug-in.

16. The computer program product of claim 14, wherein the computer usable program code for directing replication of the added plug-in to the plug-in repository comprises:
computer usable program code for receiving from the service an invocation of a replication function in the clustered computing environment within the node for the added plug-in.
